(19) United States
(12) Patent Application Publication
(10) Pub. No.: US 2026/0257494 A1
(43) Pub. Date: Sep. 3, 2026

(54) Printing Apparatus And Printing Method

(71) Applicant: SEIKO EPSON CORPORATION, Tokyo (JP)

(72) Inventors: Takayoshi KAGATA, Shiojiri (JP); Seiichi MATSUSHIMA, Matsumoto (JP); Kunihiro FUJITA, Shiojiri (JP)

(21) Appl. No.: 19/552,217

(22) Filed: Feb. 27, 2026

(30) Foreign Application Priority Data
Feb. 28, 2025 (JP) 2025-031287

(51) Int. Cl. B41J 3/407; B41J 2/005; B41J 2/01; B41J 2/21; B41J 11/06; B41J 25/00; C09D 11/104; C09D 11/30; C09D 11/54; D06P 3/60; D06P 5/00; D06P 5/24; D06P 5/30

(52) U.S. Cl. CPC B41J 3/4078; B41J 2/0057; B41J 2/2117; B41J 11/06; B41J 25/005; C09D 11/104; C09D 11/30; C09D 11/54; D06P 3/60; D06P 5/002; D06P 5/003; D06P 5/30; B41J 2002/012

(57) ABSTRACT

Provided is a printing apparatus including a mounting portion on which a cotton cloth or a transfer sheet is selectively mounted, a printing section that is configured to discharge ink for image formation and adhesive liquid, and a controller that controls operation of the printing section. The controller includes a selection section that selects one of a first mode in which the operation of the printing section is controlled such that the ink for image formation is discharged toward the cotton cloth mounted on the mounting portion so that a first image layer is formed and a second mode in which the operation of the printing section is controlled such that the ink for image formation is discharged toward the transfer sheet mounted on the mounting portion so that a second image layer is formed and the adhesive liquid is discharged toward the second image layer after formation of the second image layer so that an adhesive layer is formed.

The present application is based on, and claims priority from JP Application Serial Number 2025-031287, filed Feb. 28, 2025, the disclosure of which is hereby incorporated by reference herein in its entirety.

### BACKGROUND

### 1. Technical Field

The present disclosure relates to a printing apparatus and a printing method.

### 2. Related Art

Disclosed in JP-A-2024-168155 is an apparatus that can perform two printing methods, the two printing methods being a direct-to-cloth (DTG) method of directly forming an image at a cloth and a direct-to-film (DTF) method of forming an image at a transfer sheet and transferring, to a cloth, the image formed at the transfer sheet.

Meanwhile, the present inventors have found from studies that which of the two printing methods is suitable from the viewpoint of improving both of the robustness of a printed image and the cloth texture of a printing region depends on a condition such as the material or the like of a cloth on which printing is to be performed.

### SUMMARY

According to an application example of the present disclosure, there is provided a printing apparatus including a mounting portion on which a cotton cloth or a transfer sheet is selectively mounted, a printing section that is configured to discharge ink for image formation and adhesive liquid, and a controller that controls operation of the printing section, in which the controller includes a selection section that selects one of a first mode in which the operation of the printing section is controlled such that the ink for image formation is discharged toward the cotton cloth mounted on the mounting portion so that a first image layer is formed and a second mode in which the operation of the printing section is controlled such that the ink for image formation is discharged toward the transfer sheet mounted on the mounting portion so that a second image layer is formed and the adhesive liquid is discharged toward the second image layer after formation of the second image layer so that an adhesive layer is formed.

According to another application example of the present disclosure, there is provided a printing method including specifying whether a printing medium mounted on a mounting portion is a cotton cloth or a transfer sheet, selecting a first mode, in which ink for image formation is discharged toward the cotton cloth from a printing section so that a first image layer is formed, to be executed when the printing medium mounted on the mounting portion is the cotton cloth, and selecting a second mode, in which the ink for image formation is discharged toward the transfer sheet from the printing section so that a second image layer is formed and then adhesive liquid is discharged toward the second image layer so that an adhesive layer is formed, to be executed when the printing medium mounted on the mounting portion is the transfer sheet.

### BRIEF DESCRIPTION OF THE DRAWINGS

FIG. 1 is a perspective view showing a printing apparatus according to a first embodiment of the present disclosure.

FIG. 2 is a cross-sectional view showing a portion of a cotton cloth on which printing is performed by means of the printing apparatus of FIG. 1.

FIG. 3 is a cross-sectional view showing a portion of a transfer sheet on which printing is performed by means of the printing apparatus of FIG. 1.

FIG. 4 is a cross-sectional view showing a portion of a polyester cloth on which transfer is performed by means of the transfer sheet of FIG. 3 on which printing is performed.

FIG. 5 is a bottom view showing an ink jet head included in a printing section of the printing apparatus of FIG. 1.

FIG. 6 is a plan view showing a scanning route of the ink jet head of FIG. 5.

FIG. 7 is a block diagram showing the printing apparatus of FIG. 1.

FIG. 8 is a flowchart showing a printing method according to the first embodiment of the present disclosure.

FIG. 9 is a flowchart showing details of a step in which the printing apparatus performs printing in accordance with setting information in FIG. 8.

FIG. 10 is a cross-sectional view showing a portion of a transfer sheet on which printing is performed by means of a printing apparatus according to a second embodiment of the present disclosure.

### DESCRIPTION OF EMBODIMENTS

Hereinafter, embodiments of the present disclosure will be described with reference to the drawings. Note that the following description does not limit the technical range or the meaning of the terms described in the claims. In addition, the dimensional ratios of the drawings are exaggerated for convenience of description and may be different from the actual ratios.

Note that in each drawing, an X-axis, a Y-axis, and a Z-axis are set as three axes orthogonal to each other. Each axis is represented by an arrow, a distal end side of the arrow is a “positive side”, and a proximal end side of the arrow is a “negative side”. In the following description, for example, an “X-axis direction” includes both a positive direction and a negative direction parallel to the X-axis. The same applies to a Y-axis direction and a Z-axis direction. In addition, in the following description, particularly, a positive side in the Z-axis direction will be referred to as an “upper side” and a negative side in the Z-axis direction will be referred to as a “lower side”. The Z-axis does not need to be parallel to a vertical axis and may be inclined with respect to the vertical axis.

### First Embodiment

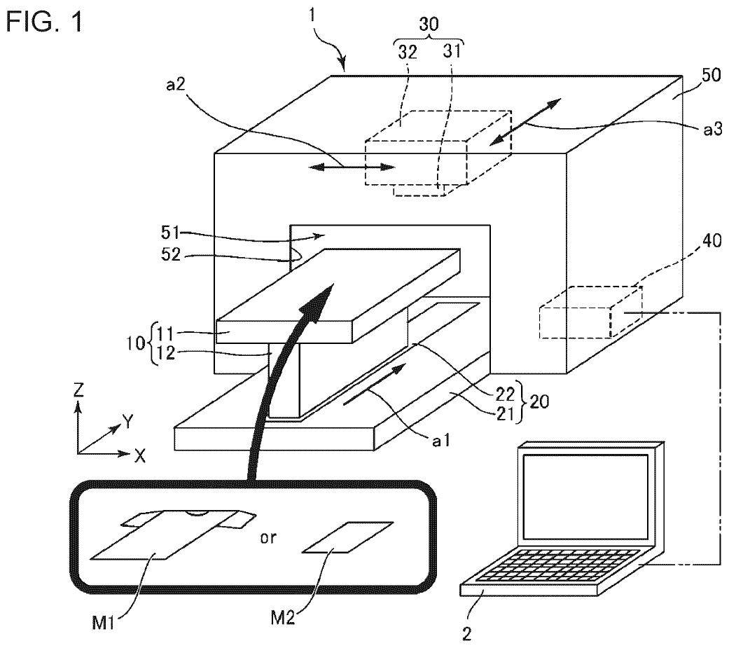

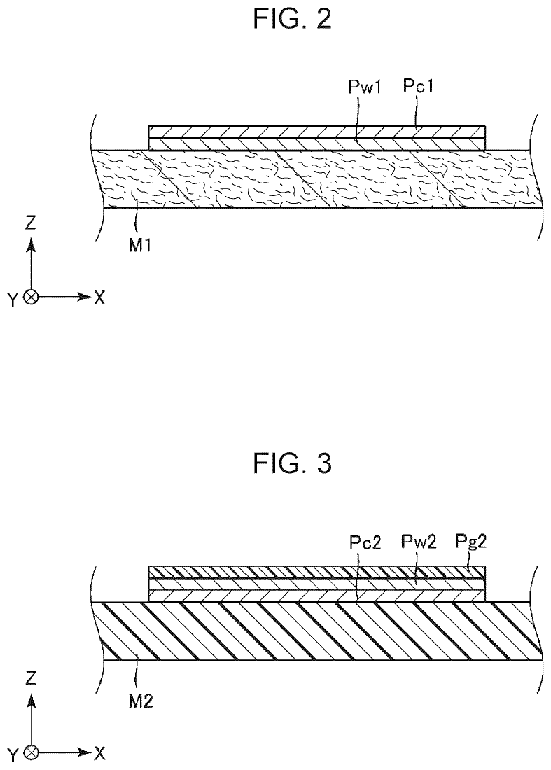

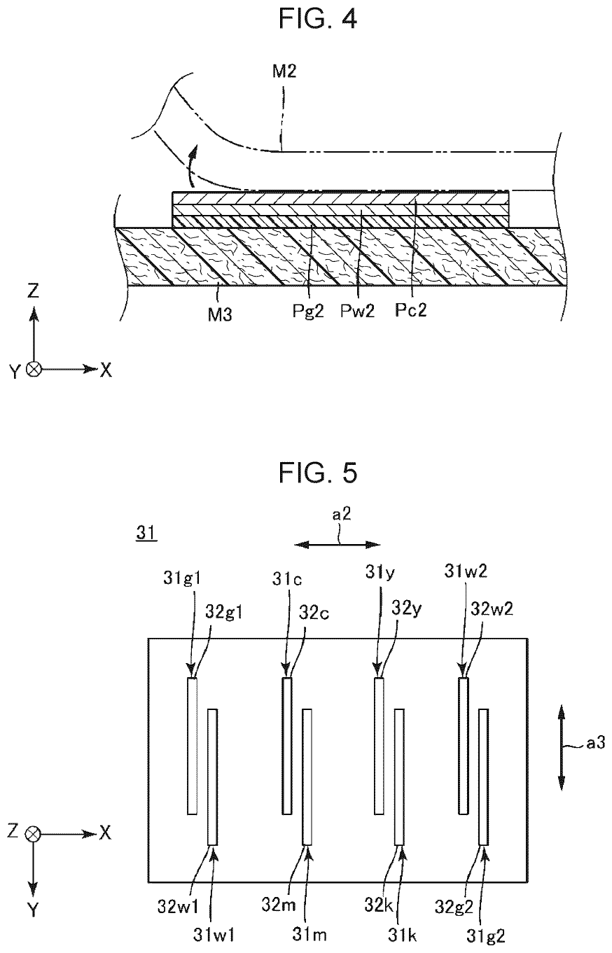

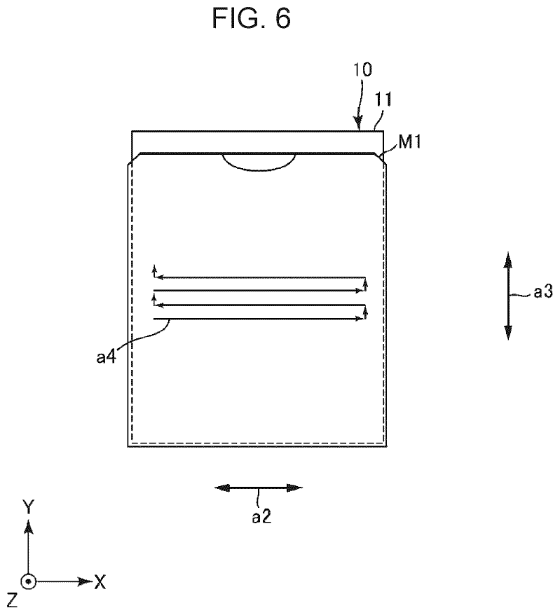

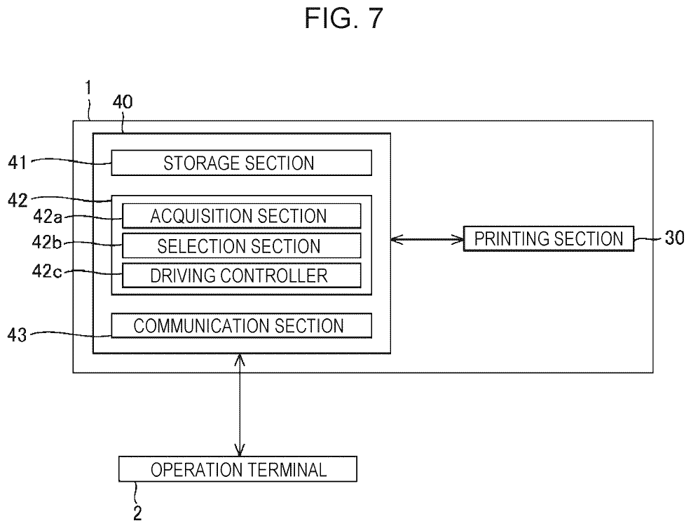

FIG. 1 is a perspective view showing a printing apparatus 1 according to a first embodiment. FIG. 2 is a cross-sectional view showing a portion of a cotton cloth M1 on which printing is performed by means of the printing apparatus 1 of FIG. 1. FIG. 3 is a cross-sectional view showing a portion of a transfer sheet M2 on which printing is performed by means of the printing apparatus 1 of FIG. 1. FIG. 4 is a cross-sectional view showing a portion of a polyester cloth M3 on which transfer is performed by means of the transfer sheet M2 of FIG. 3 on which printing is performed. FIG. 5 is a bottom view showing an ink jet head 31 included in a printing section 30 of the printing apparatus 1 of FIG. 1. FIG. 6 is a plan view showing a scanning route a4 of the ink jet head 31 of FIG. 5. FIG. 7 is a block diagram showing the printing apparatus 1 of FIG. 1.

The printing apparatus 1 according to the present embodiment is the printing apparatus 1 that can select one of two modes in accordance with the material of a cloth on which printing is to be finally performed, the two modes being a first mode corresponding to a DTG method of directly performing printing on a cloth and a second mode corresponding to a DTF method of performing printing on the transfer sheet M2. Two cases will be described in the following description, the two cases being a case where a cloth on which printing is to be finally performed is the cotton cloth M1 shown in FIGS. 1 and 2 and a case where a cloth on which printing is to be finally performed is the polyester cloth M3 shown in FIG. 4.

In the present specification, the “cotton cloth M1” refers to a cloth in which the proportion of the total mass of cotton fibers to the total mass of the cloth, that is, the mixing ratio of the cotton fibers, is 50% by mass or more. Therefore, the cotton cloth M1 may be composed of cotton fibers only or may include fibers other than the cotton fibers. Examples of the fibers other than the cotton fibers include natural fibers such as silk, hemp, and wool, regenerated fibers such as rayon, cuprammonium rayon, and polynosic, and chemical fibers such as polyester fibers, polyamide fibers, polyurethane fibers, acrylic fibers, acetate fibers, vinylon fibers, and aramid fibers.

In addition, in the present specification, the “polyester cloth M3” refers to a cloth in which the mixing ratio of fibers exceeds 50% by mass. Therefore, the polyester cloth M3 may be composed of polyester fibers only or may include fibers other than the polyester fibers and examples of the fibers other than the polyester fibers include natural fibers such as cotton, silk, hemp, and wool, regenerated fibers such as rayon, cuprammonium rayon, and polynosic, and chemical fibers such as polyamide fibers, polyurethane fibers, acrylic fibers, acetate fibers, vinylon fibers, and aramid fibers. The mixing ratio is measured by a method based on a fiber mixing ratio test specified in JIS L 1030-2:2024.

The cotton cloth M1 and the polyester cloth M3 may be a fabric (a cloth), or may be, for example, clothing such as underwear, T-shirts, dress shirts, and socks, bedding such as sheets, quilt covers, and pillow covers, and processed products (sewn products) such as towels, handkerchiefs, hand towels, and curtains. The cotton cloth M1 and the polyester cloth M3 include a woven fabric, a knitted fabric, and a nonwoven fabric. Examples of the woven fabric include a fabric with a plain weave, a fabric with a twill weave, a fabric with a satin weave. Examples of the knitted fabric include a jersey fabric and a crocheted fabric.

The transfer sheet M2 includes a sheet-shaped base material (not shown) formed of a resin and a release layer (not shown) stacked on at least one surface of the base material. The resin constituting the base material is not particularly limited, and examples thereof include polyester such as polyethylene terephthalate, polyolefin such as polyethylene and polypropylene, polyamide, polyimide, an acrylic resin, a fluorine-based resin, polyurethane, and polyvinyl chloride. The base material may be, for example, a laminate having two or more layers of which the materials are different. The release layer has a function of facilitating separation of a second image layer Pc2, which will be described later, from the transfer sheet M2. The constituent material of the release layer is not particularly limited, and examples thereof include a polyethylene wax-based release agent, a silicone-based release agent, and a fluorine-based release agent.

In the present embodiment, for the cotton cloth M1, printing is performed by means of the printing apparatus 1 in the first mode corresponding to the DTG method. In addition, for the polyester cloth M3, first, printing is performed on the transfer sheet M2 by means of the printing apparatus 1 in the second mode corresponding to the DTF method and then an image on the transfer sheet M2, on which the printing is performed, is transferred to the polyester cloth M3.

Specifically, in the first mode corresponding to the DTG method, although details will be described later, ink for image formation is discharged toward the cotton cloth M1 from the printing section 30 of the printing apparatus 1 which will be described later so that an image layer Pc1 corresponding to data of a desired image to be printed is formed as shown in FIG. 2. Note that in the present specification, cases represented by the expression “B is discharged toward A so that a C layer is formed” include not only a case where B is directly discharged onto A so that the C layer composed of B is formed at A but a case where B is discharged toward A via a D layer in a state where the D layer is formed at A so that the C layer is formed at the D layer, A being a member such as the cotton cloth M1 and B being discharging target liquid such as ink for image formation. Therefore, ink for image formation may be discharged as described above to form the image layer Pc1 after white ink is discharged toward the cotton cloth M1 from the printing section 30 so that a background layer Pw1 is formed (refer to FIG. 2). When the image layer Pc1 is formed at the background layer Pw1, the color development properties of the image layer Pc1 can be improved regardless of the color of the cotton cloth M1. Hereinafter, the image layer Pc1 formed in the first mode may be referred to as a “first image layer Pc1”, and a background layer formed in the first mode may be referred to as a “first background layer Pw1”.

In the second mode corresponding to the DTF method, although details will be described later, as shown in FIG. 3, ink for image formation is discharged from the printing section 30 toward the transfer sheet M2 by the printing apparatus 1 so that an image layer Pc2 corresponding to an inverted image of the data of the desired image is formed and then adhesive liquid is discharged from the printing section 30 toward the image layer Pc2 so that an adhesive layer Pg2 is formed. Note that white ink may be discharged from the printing section 30 after the ink for image formation is discharged and before the adhesive liquid is discharged so that a background layer Pw2 is formed between the adhesive layer Pg2 and the image layer Pc2 (refer to FIG. 3). Next, the transfer sheet M2 taken out from the printing apparatus 1 is dried by being heated or the like by means of a dryer (not shown) different from the printing apparatus 1. Next, an image printed on the transfer sheet M2 is transferred to the polyester cloth M3 by means of a transfer machine (not shown) different from the printing apparatus 1. Specifically, as shown in FIG. 4, the adhesive layer Pg2 of the transfer sheet M2 is affixed to the polyester cloth M3 and is heat-pressed. Accordingly, the adhesive layer Pg2 is thermally welded to the polyester cloth M3. Then, as shown by an arrow in FIG. 4, the transfer sheet M2 is separated from the image layer Pc2. Accordingly, the image layer Pc2 is transferred to the polyester cloth M3. Hereinafter, the image layer Pc2 formed in the second mode may be referred to as a “second image layer Pc2”, and the background layer Pw2 formed in the second mode may be referred to as a “second background layer Pw2”.

In addition, hereinafter, when the image layers Pc1 and Pc2 and the background layers Pw1 and Pw2 are formed, all the image layers Pc1 and Pc2 and the background layers Pw1 and Pw2 will be simply referred to as “printed images”. The present inventors have found from intensive studies that performing printing with the DTG method can result in favorable properties of the cotton cloth M1 such as the robustness of a printed image and the texture of a printing region. Here, the “robustness” means a degree to which a printed image is less likely to be cracked, damaged, or the like when a cloth is washed or the like, that is, the durability of the printed image. In addition, the “texture” means the texture or an impression felt at the time of contact, and means a sensory evaluation of the feel of a material or the texture such as the texture felt by hands, the texture felt by skin, and comfort of wearing. It is considered that the reason of such a difference depending on the material of a cloth is as follows.

The cotton cloth M1 has relatively high hydrophilicity. However, a main component of adhesive liquid used in the DTF method is thermoplastic resin, and has relatively high hydrophobicity (lipophilicity). Therefore, when printing is performed on the cotton cloth M1 by means of the DTF method, that is, when the adhesive layer Pg2 of the transfer sheet M2 is affixed to the cotton cloth M1, a force that causes the adhesive layer Pg2 to adhere to the cotton cloth M1 is relatively weak since the affinity between the cotton cloth M1 and the adhesive layer Pg2 is relatively low. Accordingly, it is considered that the robustness of a printed image is reduced when printing is performed on the cotton cloth M1 by means of the DTF method. However, when printing is performed on the cotton cloth M1 by means of the DTG method, the first background layer Pw1 and the first image layer Pc1 are formed at the cotton cloth M1 without the adhesive layer Pg2 interposed therebetween. Therefore, in the case of the DTG method, the robustness of a printed image on the cotton cloth M1 can be improved in comparison with the DTF method.

In addition, the cotton cloth M1 has a relatively excellent texture. For example, the feel of the cotton cloth M1 is soft. Therefore, when printing is performed on the cotton cloth M1 by means of the DTF method, the feel of a region (a printing region) in which the adhesive layer Pg2 is thermally welded to the cotton cloth M1 is hard and rough, so that deterioration in texture is likely to be felt. However, when printing is performed on the cotton cloth M1 by means of the DTG method, the adhesive layer Pg2 is not thermally welded and white ink or ink for image formation is discharged onto the cotton cloth M1 from the printing section 30 so that the first background layer Pw1 or the first image layer Pc1 is formed. Therefore, in the case of the DTG method, the texture of a printing region on the cotton cloth M1 can be made favorable in comparison with the DTF method.

Meanwhile, the present inventors have found from intensive studies that performing printing on the polyester cloth M3 with the DTF method can result in the favorable robustness of a printed image and the favorable texture of a printing region. It is considered that the reason for this is as follows.

The polyester cloth M3 has relatively high hydrophobicity. In addition, a main component of adhesive liquid used in the DTF method is thermoplastic resin, and has relatively high hydrophobicity. Therefore, when printing is performed on the polyester cloth M3 by means of the DTF method, a force that causes the adhesive layer Pg2 to adhere to the polyester cloth M3 is relatively strong since the affinity between the polyester cloth M3 and the adhesive layer Pg2 is relatively high. Therefore, in the case of the DTF method, the robustness of a printed image on the polyester cloth M3 can be improved in comparison with the DTG method.

In addition, the polyester cloth M3 tends to have a poorer texture than the cotton cloth M1. Therefore, even when the adhesive layer Pg2 is thermally welded to the polyester cloth M3 in a case where printing is performed on the polyester cloth M3 by means of the DTF method, deterioration in texture of a printing region with respect to the texture of a fabric itself is less likely to be felt.

In addition, according to additional studies of the present inventors, performing printing on the polyester cloth M3 with the DTF method can result in favorable color development properties of a printed image. It is considered that the reason for this is as follows. The polyester cloth M3 is often used for sportswear that requires breathability, and has relatively coarse pores in many cases. Therefore, when printing is performed on the polyester cloth M3 by means of the DTG method, ink for image formation is likely to pass through pores of the polyester cloth M3 and thus deterioration in color development properties is likely to occur. However, when printing is performed on the polyester cloth M3 by means of the DTF method, since the second image layer Pc2 formed at the transfer sheet M2 is transferred to the polyester cloth M3, color development properties can be made favorable.

Based on the above, the configuration of the printing apparatus 1 will be described. In the following description, the cotton cloth M1 and the transfer sheet M2, which are targets on which the printing apparatus 1 performs printing directly, may be collectively referred to as “printing mediums”. To briefly describe the printing apparatus 1 with reference to FIG. 1, the printing apparatus 1 includes a mounting portion 10 on which the cotton cloth M1 or the transfer sheet M2 is selectively mounted, a base 20 that supports the mounting portion 10 to be movable, the printing section 30 that performs printing on a printing medium, a controller 40 that controls the operation of the printing section 30, and a housing 50 that accommodates the printing section 30 and the controller 40.

The mounting portion 10 includes a flat plate-shaped mounting table (a platen) 11 that is approximately parallel to an X-Y plane and a supporting portion 12 that is disposed below the mounting table 11, that extends in a Z direction, and that supports the mounting table 11. A printing medium is disposed on the mounting table 11.

The base 20 is disposed below the supporting portion 12 and is drawn out through an opening 52 of the housing 50, which will be described later. The base 20 includes a main body portion 21 that is approximately parallel to the X-Y plane and has a flat plate-like shape, and a guide portion 22 that is disposed on the main body portion 21, that extends along the Y-axis direction, and that guides the mounting portion 10 moving in the Y-axis direction. The guide portion 22 is composed of, for example, a rail, a groove, or the like that extends along the Y-axis direction.

As represented by an arrow a1 in FIG. 1, the mounting portion 10 is movable from a mounting position, at which the mounting portion 10 is positioned outside the housing 50 and the printing medium is mounted onto the mounting portion 10, to a printing position, at which the mounting portion 10 is positioned inside the housing 50 and printing is performed on the printing medium, in the Y-axis direction along the guide portion 22. The mounting portion 10 may be manually moved from the mounting position to the printing position by an operator or the guide portion 22 may be provided with a transportation unit such as an electric belt transportation mechanism, a ball screw mechanism, or a rack and pinion mechanism so that the mounting portion 10 is automatically moved from the mounting position to the printing position by the transportation unit. In addition, the mounting portion 10 and the base 20 may be accommodated in the housing 50 when the printing apparatus 1 is not to be used.

The printing section 30 selectively discharges ink such as ink for image formation and white ink or adhesive liquid toward the printing medium mounted on the mounting portion 10 so that a predetermined pattern is formed at the printing medium. In the present specification, the adhesive liquid, the white ink, and the ink for image formation may be collectively referred to as “discharging target liquid”. The printing section 30 includes the ink jet head 31 that can discharge the ink for image formation, the white ink, and the adhesive liquid and a carriage 32 that can move the ink jet head 31 in a main scanning direction a2 and a sub-scanning direction a3. In addition, the printing section 30 is coupled to a discharging target liquid supply source (a discharging target liquid storage portion) (not shown) from which the ink for image formation, the white ink, and the adhesive liquid is supplied to the printing section 30. In the present embodiment, the main scanning direction a2 coincides with the X-axis direction, and the sub-scanning direction a3 coincides with the Y-axis direction.

In the present embodiment, the ink for image formation is aqueous ink containing a coloring material and water. Examples of the coloring material include a pigment, a dye, and the like, and a mixture of one or two or more of the pigment and the dye can be used. In addition, the coloring material may further include a fluorescent agent and an optical modulation material. The ink for image formation may further contain at least one of an organic solvent, a resin, a surfactant, a pH adjuster, a chelating agent, a drying agent, a plasticizer, a stabilizer, an antibacterial/antifungal agent, an antistatic agent, and a filler.

In the present embodiment, as the ink for image formation, there are four types of color inks which are cyan ink (C), magenta ink (M), yellow ink (Y), and black ink (K). However, the colors of the ink for image formation, the number of the colors of the ink for image formation, and the types of the ink for image formation are not limited thereto. For example, as the ink for image formation, ink having a metal color or ink having a fluorescent color may be included. The amount of a coloring material contained in the ink for image formation is not particularly limited but is preferably 5% by mass or more and 20% by mass or less and more preferably 8% by mass or more and 15% by mass or less.

The white ink is aqueous ink containing a white coloring material such as titanium dioxide, calcium carbonate, and aluminum hydroxide, and water. The white ink may further contain at least one of an organic solvent, a resin, a surfactant, a pH adjuster, a chelating agent, a drying agent, a plasticizer, a stabilizer, an antibacterial/antifungal agent, and an antistatic agent. The amount of a white coloring material contained in the white ink is not particularly limited but is preferably 5% by mass or more and 20% by mass or less and more preferably 8% by mass or more and 15% by mass or less.

An organic solvent to be used in the ink for image formation and the white ink is not particularly limited and examples thereof include: glycerin; glycols such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, and 1,6-hexanediol; glycol monoethers such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, and triethylene glycol monomethyl ether; nitrogen-containing solvents such as 2-pyrrolidone, N-methyl-2-pyrrolidone, and N-ethyl-2-pyrrolidone; and alcohols such as methanol, ethanol, n-propyl alcohol, isopropyl alcohol, n-butanol, 2-butanol, tert-butanol, iso-butanol, n-pentanol, 2-pentanol, 3-pentanol, and tert-pentanol. One of such organic solvents may be used alone, or two or more of the organic solvents may be used in combination.

A resin to be used in the ink for image formation and the white ink is not particularly limited and examples thereof include urethane-based resins such as polyurethane, acrylic resins, styrene-based resins, rosin, polyamides, alkyd resins, epoxy-based resins, and phenolic resins. The amount of a resin contained in the ink for image formation is not particularly limited but is preferably 5% by mass or more and 20% by mass or less and more preferably 8% by mass or more and 15% by mass or less. The amount of a resin contained in the white ink is not particularly limited but is preferably 5% by mass or more and 20% by mass or less and more preferably 8% by mass or more and 15% by mass or less.

A surfactant to be used in the ink for image formation and the white ink is not particularly limited and examples thereof include nonionic surfactants, anionic surfactants, cationic surfactants, and amphoteric surfactants.

The water content of the ink for image formation and the water content of the white ink are preferably 40% by mass or more and 80% by mass or less and more preferably 50% by mass or more and 70% by mass or less. In this case, ink viscosity can be made appropriate and ink can be favorably discharged from the ink jet head 31.

The adhesive liquid is an aqueous adhesive agent containing a resin and water. The resin constituting the adhesive liquid is preferably a thermoplastic resin such as polyester. When polyester is used as the resin constituting the adhesive liquid, a force that causes the adhesive layer Pg2 to adhere to the polyester cloth M3 can be further enhanced. As a result, the robustness of a printed image on the polyester cloth M3 can be further improved. Examples of the polyester include polyethylene terephthalate, polybutylene terephthalate, polyethylene naphthalate, and a mixture of two or more of these.

The adhesive liquid may further contain at least one of a coloring material, an organic solvent, a resin, a surfactant, a pH adjuster, a chelating agent, a drying agent, a plasticizer, a stabilizer, an antibacterial/antifungal agent, and an antistatic agent. Examples of an organic solvent used in the adhesive liquid include the same organic solvents as those described above. Examples of a surfactant used in the adhesive liquid include the same surfactants as those described above.

A glass transition temperature Tg of the resin constituting the adhesive liquid is not particularly limited but is preferably 15° C. or higher and 55° C. or lower and more preferably 20° C. or higher and 50° C. or lower. When the glass transition temperature Tg of the resin constituting the adhesive liquid is set to fall within the above-described range, the fluidity of the adhesive liquid at a normal temperature is improved and the application properties of the adhesive liquid can be made favorable.

A melting point of the resin constituting the adhesive liquid is not particularly limited but is preferably 75° C. or higher and 145° C. or lower and more preferably 80° C. or higher and 140° C. or lower. When the melting point of the resin constituting the adhesive liquid is set to fall within the above-described range, the adhesive layer Pg2 heat-pressed by means of the transfer machine is firmly thermally welded to the polyester cloth M3 and the robustness of the printed image on the polyester cloth M3 can be improved.

Here, the solid content of the adhesive liquid is mainly the resin. When the adhesive liquid contains an additive agent (a coloring material) or the like that is insoluble in water, the additive agent or the like is also the solid content but the amount thereof is very small in comparison with the resin. Therefore, hereinafter, the “solid content of the adhesive liquid” refers to the amount of the resin in the adhesive liquid. A solid content concentration of the adhesive liquid is not particularly limited but is preferably 2% by mass or more and 30% by mass or less and more preferably 5% by mass or more and 20% by mass or less. When the solid content concentration of the adhesive liquid is set to be equal to or higher than the above-described lower limit values, a force that causes the adhesive liquid to adhere to the transfer sheet M2 can be secured sufficiently. In addition, when the solid content concentration of the adhesive liquid is set to be equal to or lower than the upper limit values, an excessive increase in viscosity of the adhesive liquid is suppressed, and the application properties of the adhesive liquid applied by the printing section 30 can be made favorable.

In the present embodiment, the ink jet head 31 is operated by a piezoelectric method. However, the ink jet head 31 may be operated by a thermal method. The ink jet head 31 includes a head main body in which an in-head flow path (not shown) filled with the discharging target liquid is formed for each type of discharging target liquid. In addition, the head main body is provided with a discharge portion that is provided for each type of discharging target liquid and is composed of a group of a plurality of nozzles that communicate with a flow path and that include openings. In addition, the head main body is provided with a piezoelectric element (a piezoelectric body) for each discharge portion. When a voltage is applied to a piezoelectric element, predetermined discharging target liquid is discharged in the form of liquid droplets from a discharge portion.

As shown in FIG. 5, at the ink jet head 31, as the discharge portions, a first adhesive liquid discharge portion 31g1, a first white ink discharge portion 31w1, a cyan ink discharge portion 31c, a magenta ink discharge portion 31m, a yellow ink discharge portion 31y, a black ink discharge portion 31k, a second white ink discharge portion 31w2, and a second adhesive liquid discharge portion 31g2 are provided in the X-axis direction in this order.

The first adhesive liquid discharge portion 31g1 is composed of a first nozzle group 32g1 that discharges the adhesive liquid. Similarly, the second adhesive liquid discharge portion 31g2 is composed of a second nozzle group 32g2 that discharges the adhesive liquid. The first white ink discharge portion 31w1 is composed of a first nozzle group 32w1 that discharges the white ink. Similarly, the second white ink discharge portion 31w2 is composed of a second nozzle group 32w2 that discharges the white ink.

As described above, in the present embodiment, the printing section 30 is provided with a plurality of adhesive liquid discharge portions 31g1 and 31g2 and the printing section 30 is provided with a plurality of white ink discharge portions 31w1 and 31w2. The adhesive liquid and the white ink need to adhere to a relatively wide range overlapping the image layers Pc1 and Pc2 as seen in plan view and in the case of the above-described configuration, it is possible to cause the adhesive liquid and the white ink to adhere to a relatively wide range in a short time, efficiently. In addition, in the case of the above-described configuration, the adhesive layer Pg2 and the background layers Pw1 and Pw2 that are uniform in thickness and that are homogeneous can be formed.

The cyan ink discharge portion 31c is composed of a nozzle group 32c that discharges cyan ink. The magenta ink discharge portion 31m is composed of a nozzle group 32m that discharges magenta ink. The yellow ink discharge portion 31y is composed of a nozzle group 32y that discharges yellow ink. The black ink discharge portion 31k is composed of a nozzle group 32k that discharges black ink.

Note that although each of the nozzle groups 32g1, 32w1, 32c, 32m, 32y, 32k, 32w2, and 32g2 is composed of a plurality of nozzles arranged in the Y-axis direction, the plurality of nozzles are schematically represented by one rectangle in FIG. 5.

However, the configuration of the printing section 30 is not limited to the above-described configuration. For example, the number of ink jet heads 31 and the number of carriages 32 provided for the printing section 30 may be two or more. In this case, a plurality of ink jet heads 31 may be provided with an adhesive liquid discharge portion, a white ink discharge portion, and an ink-for-image-formation discharge portion in a distributed manner. In addition, the number of discharge portions for each discharging target liquid type in the printing section 30 is not limited to the above-described number, and may be one or more.

In addition, the present disclosure is not limited to a configuration in which the carriage 32 moves the ink jet head 31 in the sub-scanning direction a3 (the Y-axis direction) and the mounting portion 10 may be moved in the sub-scanning direction a3 by the transportation unit or the like provided at the base 20 so that the ink jet head 31 is relatively moved with respect to the mounting portion 10. In addition, the printing section 30 may be a line type printing section in which a plurality of nozzles are arranged in the X-axis direction of a printing region for each discharge portion. In this case, the ink jet head 31 only need to be relatively movable in the Y-axis direction with respect to the mounting portion 10.

As shown in FIG. 1, the housing 50 has a rectangular parallelepiped-like shape, an internal space 51 in which the mounting portion 10 is disposed at the time of printing is formed at the housing 50 and the opening 52 that communicates with the internal space 51 is formed at a side surface of the housing 50 that is on a negative side in the Y-axis direction. The base 20 is drawn out to the negative side in the Y-axis direction through the opening 52 when printing is not to be started yet. In addition, the ink jet head 31 waits at a waiting position, which is a position offset from the printing medium on the mounting table 11 in the X-axis direction as seen in the Z-axis direction, when printing is not to be started yet.

As shown in FIG. 7, the controller 40 includes a storage section 41 that stores various types of data and various types of programs necessary for the operation of the printing apparatus 1, a processing section 42 that reads the various types of data and the various types of programs stored in the storage section 41 and performs various types of processes, and a communication section 43 that communicates with an external device such as an operation terminal 2 of a user. The storage section 41, the processing section 42, and the communication section 43 are coupled via a bus. Examples of the operation terminal 2 of the user include a personal computer (PC), a smartphone, and a tablet.

The storage section 41 is composed of a memory such as a random access memory (RAM) or a read only memory (ROM). The storage section 41 stores printing conditions in the first mode and printing conditions in the second mode, which will be described below.

The communication section 43 is composed of an interface that can communicate with the operation terminal 2 of the user wirelessly or via a wired connection.

The processing section 42 is composed of, for example, at least one processor such as a central processing unit (CPU). The user sets, by using the operation terminal 2, printing setting information including information about the material of a printing medium mounted on the mounting portion 10, image data to be printed, whether or not the white ink is to be used, and the like. The processing section 42 includes an acquisition section 42a that acquires the setting information from the operation terminal 2 of the user via the communication section 43, a selection section 42b that selects a mode in accordance with set conditions, and a driving controller 42c that controls the operation of each part in accordance with the selected mode.

As described above, the printing apparatus 1 can operate in the two modes, the two modes being the first mode that corresponds to the DTG and in which printing is performed on the cotton cloth M1 and the second mode that corresponds to the DTF and in which printing is performed on the transfer sheet M2. Any one of the first mode or the second mode is executed depending on the mode selected by the selection section 42b. More specifically, the first mode is further divided into a first sub-mode in which the white ink is used and a second sub-mode in which the white ink is not used. The second mode is further divided into a third sub-mode in which the white ink is used and a fourth sub-mode in which the white ink is not used.

When it is specified from acquired setting information that the cotton cloth M1 is mounted on the mounting portion 10 and the white ink is to be used, the selection section 42b selects the first sub-mode of the first mode. When the first sub-mode is selected, the driving controller 42c controls the operation of the printing section 30 such that the white ink is discharged toward the cotton cloth M1 so that the first background layer Pw1 is formed and then the ink for image formation is discharged toward the first background layer Pw1 so that the first image layer Pc1 corresponding to image data in the setting information is formed, as shown in FIG. 2.

Specifically, in the first sub-mode, when the first background layer Pw1 is to be formed, the ink jet head 31 is repeatedly moved to one side (the positive side in the X-axis direction) in the main scanning direction a2, one side (the positive side in the Y-axis direction) in the sub-scanning direction a3, the other side (the negative side in the X-axis direction) in the main scanning direction a2, and the one side (the positive side in the Y-axis direction) in the sub-scanning direction a3 in this order as represented by the scanning route a4 in FIG. 6. In addition, while the ink jet head 31 is moving in such a manner, the white ink is discharged from a predetermined discharge portion of the ink jet head 31 at positions corresponding to the image data so that the first background layer Pw1 is formed.

In addition, when the first image layer Pc1 is to be formed, the ink jet head 31 is moved reversely, along the scanning route a4 along which the ink jet head 31 is moved at the time of formation of the first background layer Pw1. In addition, while the ink jet head 31 is moving in such a manner, the ink for image formation is discharged from a predetermined discharge portion of the ink jet head 31 at positions corresponding to the image data so that the first image layer Pc1 is formed.

That is, the ink jet head 31 discharges the white ink during a forward movement in the sub-scanning direction a3 and discharges the ink for image formation during a backward movement. Therefore, the first background layer Pw1 is formed during the forward movement in the sub-scanning direction a3, and the first image layer Pc1 is formed during the backward movement in the sub-scanning direction a3. Since the printing section 30 performs discharge during both of the forward movement and the backward movement in the sub-scanning direction a3 in this manner, printing can be efficiently performed in comparison with a case where the printing section 30 performs discharge during only one of the forward movement or the backward movement in the sub-scanning direction a3. In addition, a time required for printing can be shortened.

In addition, when it is specified from the acquired setting information that the cotton cloth M1 is mounted on the mounting portion 10 and the white ink is not to be used, the selection section 42b selects the second sub-mode of the first mode. In the second sub-mode, the driving controller 42c controls the operation of the printing section 30 such that the ink for image formation is discharged toward the cotton cloth M1 so that the first image layer Pc1 corresponding to the image data is formed.

Specifically, in the second sub-mode, when the first image layer Pc1 is to be formed, the ink jet head 31 is repeatedly moved to the one side (the positive side in the X-axis direction) in the main scanning direction a2, the one side (the positive side in the Y-axis direction) in the sub-scanning direction a3, the other side (the negative side in the X-axis direction) in the main scanning direction a2, and the one side (the positive side in the Y-axis direction) in the sub-scanning direction a3 in this order. In addition, while the ink jet head 31 is moving in such a manner, the ink for image formation is discharged from a predetermined discharge portion of the ink jet head 31 at positions corresponding to the image data so that the first image layer Pc1 is formed.

In addition, when it is specified from the acquired setting information that the transfer sheet M2 is mounted on the mounting portion 10 and the white ink is to be used, the selection section 42b selects the third sub-mode of the second mode. In the third sub-mode, the driving controller 42c controls the operation of the printing section 30 such that the ink for image formation is discharged toward the transfer sheet M2 so that the second image layer Pc2 corresponding to an inverted image of the image data is formed, the white ink is discharged toward the second image layer Pc2 so that the second background layer Pw2 is formed, and then the adhesive liquid is discharged toward the second background layer Pw2 so that the adhesive layer Pg2 is formed, as shown in FIG. 3.

Specifically, in the third sub-mode, when the second image layer Pc2 is to be formed, the ink jet head 31 is repeatedly moved to the one side (the positive side in the X-axis direction) in the main scanning direction a2, the one side (the positive side in the Y-axis direction) in the sub-scanning direction a3, the other side (the negative side in the X-axis direction) in the main scanning direction a2, and the one side (the positive side in the Y-axis direction) in the sub-scanning direction a3 in this order. In addition, while the ink jet head 31 is moving in such a manner, the ink for image formation is discharged from a predetermined discharge portion of the ink jet head 31 at a position corresponding to the inverted image so that the second image layer Pc2 is formed.

In addition, when the second background layer Pw2 is to be formed, the ink jet head 31 is moved reversely, along the scanning route along which the ink jet head 31 is moved at the time of formation of the second image layer Pc2. In addition, while the ink jet head 31 is moving in such a manner, the white ink is discharged from a predetermined discharge portion of the ink jet head 31 at a position corresponding to the inverted image so that the second background layer Pw2 is formed.

In addition, when the adhesive layer Pg2 is to be formed, the ink jet head 31 is moved in the same direction, along the scanning route along which the ink jet head 31 is moved at the time of formation of the second image layer Pc2. In addition, while the ink jet head 31 is moving in such a manner, the adhesive liquid is discharged from a predetermined discharge portion of the ink jet head 31 at a position corresponding to the inverted image so that the adhesive layer Pg2 is formed.

That is, in the third sub-mode, the ink jet head 31 discharges the ink for image formation during the first forward movement in the sub-scanning direction a3, discharges the white ink during the first backward movement, and discharges the adhesive liquid during the second forward movement. Therefore, the second image layer Pc2 is formed during the first forward movement, the second background layer Pw2 is formed during the first backward movement, and the adhesive layer Pg2 is formed during the second forward movement. Since the printing section 30 performs discharge during both of the forward movement and the backward movement in the sub-scanning direction a3 in this manner, printing can be efficiently performed in comparison with a case where the printing section 30 performs discharge during only one of the forward movement or the backward movement in the sub-scanning direction a3. In addition, a time required for printing can be shortened.

In addition, when it is specified from the acquired setting information that the transfer sheet M2 is mounted on the mounting portion 10 and the white ink is not to be used, the selection section 42b selects the fourth sub-mode of the second mode. In the fourth sub-mode, the driving controller 42c controls the operation of the printing section 30 such that the ink for image formation is discharged toward the transfer sheet M2 so that the second image layer Pc2 corresponding to the inverted image is formed and the adhesive liquid is discharged toward the second image layer Pc2 so that the adhesive layer Pg2 is formed.

Specifically, in the fourth sub-mode, when the second image layer Pc2 is to be formed, the ink jet head 31 is repeatedly moved to the one side (the positive side in the X-axis direction) in the main scanning direction a2, the one side (the positive side in the Y-axis direction) in the sub-scanning direction a3, the other side (the negative side in the X-axis direction) in the main scanning direction a2, and the one side (the positive side in the Y-axis direction) in the sub-scanning direction a3 in this order. In addition, while the ink jet head 31 is moving in such a manner, the ink for image formation is discharged from a predetermined discharge portion of the ink jet head 31 at a position corresponding to the inverted image so that the second image layer Pc2 is formed.

In addition, when the adhesive layer Pg2 is to be formed, the ink jet head 31 is moved reversely, along the scanning route along which the ink jet head 31 is moved at the time of formation of the second image layer Pc2. In addition, while the ink jet head 31 is moving in such a manner, the adhesive liquid is discharged from a predetermined discharge portion of the ink jet head 31 at a position corresponding to the inverted image so that the adhesive layer Pg2 is formed.

That is, the ink jet head 31 discharges the ink for image formation during a forward movement in the sub-scanning direction a3 and discharges the adhesive liquid during a backward movement. Therefore, the second image layer Pc2 is formed during the forward movement in the sub-scanning direction a3, and the adhesive layer Pg2 is formed during the backward movement in the sub-scanning direction a3. Since the printing section 30 performs discharge during both of the forward movement and the backward movement in the sub-scanning direction a3 in this manner, printing can be efficiently performed in comparison with a case where the printing section 30 performs discharge during only one of the forward movement or the backward movement in the sub-scanning direction a3. In addition, a time required for printing can be shortened.

However, the scanning route a4 of the ink jet head 31 is not limited to the above-described route. For example, a route at the time of the forward movement of the ink jet head 31 in the sub-scanning direction a3 may not coincide with a route at the time of the backward movement of the ink jet head 31 in the sub-scanning direction a3. In addition, for example, a scanning route along which the ink jet head 31 moves in the sub-scanning direction a3 after reciprocating in the main scanning direction a2 may also be adopted.

Next, a difference between printing conditions in the first mode and printing conditions in the second mode will be described. Printing conditions in the present embodiment include the amount of application of the white ink and a time interval between the end of discharge of one type of discharging target liquid from the ink jet head 31 and the start of discharge of another type of discharging target liquid.

In the present embodiment, an amount of application W1 of the white ink in the first mode is larger than an amount of application W2 of the white ink in the second mode. That is, W1>W2. In the present specification, the “amounts of application W1 and W2” mean the mass of the white ink per unit area in a region to which the white ink applied to a printing medium adheres and the unit thereof is usually g/m². The cotton cloth M1 has a relatively high water absorbency in comparison with the transfer sheet M2. Therefore, since W1>W2, the first background layer Pw1 having a sufficient thickness can be formed at the cotton cloth M1 even when the cotton cloth M1 absorbs a portion of the white ink. Therefore, the color development properties of the first image layer Pc1 formed at the first background layer Pw1 can be made favorable. Meanwhile, the transfer sheet M2 has a relatively low water absorbency. Therefore, since W1>W2, the second background layer Pw2 formed at the transfer sheet M2 can be rapidly desolventized (dried) and the second background layer Pw2 can be made less likely to become excessively thick. Accordingly, the white ink can be efficiently used in accordance with a mode and the more uniform second background layer Pw2 can be obtained.

A ratio W1/W2 between the amounts of application is not particularly limited but is preferably 1.5 or more and 4.0 or less and more preferably 2.0 or more and 3.0 or less. The amount of application W1 is not particularly limited but is preferably 30 g/m² or more and 160 g/m² or less and more preferably 40 g/m² or more and 120 g/m² or less. The amount of application W2 is not particularly limited but is preferably 20 g/m² or more and 40 g/m² or less and more preferably 25 g/m² or more and 35 g/m² or less.

In addition, a time interval Δt1 between the end of discharge of the white ink and the start of discharge of the ink for image formation in the first sub-mode is longer than a time interval Δt2 between the end of discharge of the white ink and the start of discharge of the adhesive liquid in the third sub-mode. That is, Δt1>Δt2. Accordingly, at the time of printing performed on the cotton cloth M1 for which the amount of application W1 of the white ink is relatively large, the first image layer Pc1 can be formed after the amount of a solvent such as water contained in the first background layer Pw1 is sufficiently reduced, that is, the first background layer Pw1 is sufficiently desolventized. Therefore, the white ink and the ink for image formation can be made less likely to be mixed and the printed image can be prevented can be made less likely to be blurred. In addition, at the time of printing performed on the transfer sheet M2 for which the amount of application W2 of the white ink is relatively small, an excessive increase in length of a time between the end of formation of the second background layer Pw2 and the start of formation of the adhesive layer Pg2 can be suppressed, which results in a decrease in printing time. Particularly, in the present embodiment, the printing section 30 is provided with the two white ink discharge portions 31w1 and 31w2. Therefore, it is possible to easily change the amounts of application W1 and W2 of the white ink depending on a plurality of modes by changing the number of the white ink discharge portions 31w1 and 31w2 to be used depending on a mode.

A ratio Δt1/Δt2 between the time intervals is not particularly limited but is preferably 2 or more and 4 or less and more preferably 3 or more and 4 or less. The time interval Δt1 is not particularly limited but is preferably 4 seconds or more and 20 seconds or less and more preferably 6 seconds or more and 16 seconds or less. The time interval Δt2 is not particularly limited but is preferably 2 seconds or more and 5 seconds or less and more preferably 2 seconds or more and 4 seconds or less.

Note that it is preferable that a time interval Δt3 between the end of discharge of the ink for image formation and the start of discharge of the white ink in the third sub-mode and a time interval Δt4 between the end of discharge of the ink for image formation and the start of discharge of the adhesive liquid in the fourth sub-mode are set to be shorter than the time interval Δt1. In this case, a time required for printing in the second mode can be shortened. The time interval Δt3 and the time interval Δt4 may be, for example, equal to or different from the time interval Δt2.

However, the printing conditions are not limited to the above-described conditions. For example, an amount relationship between the amount of application W1 and the amount of application W2 is not limited to the above-described relationship, and the amount of application W1 may be equal to the amount of application W2. In addition, a length relationship between the time interval Δt1 and the time interval Δt2 is not limited to the above-described relationship, and the time interval Δt1 may be equal to the time interval Δt2.

Next, a printing method according to the present embodiment will be described.

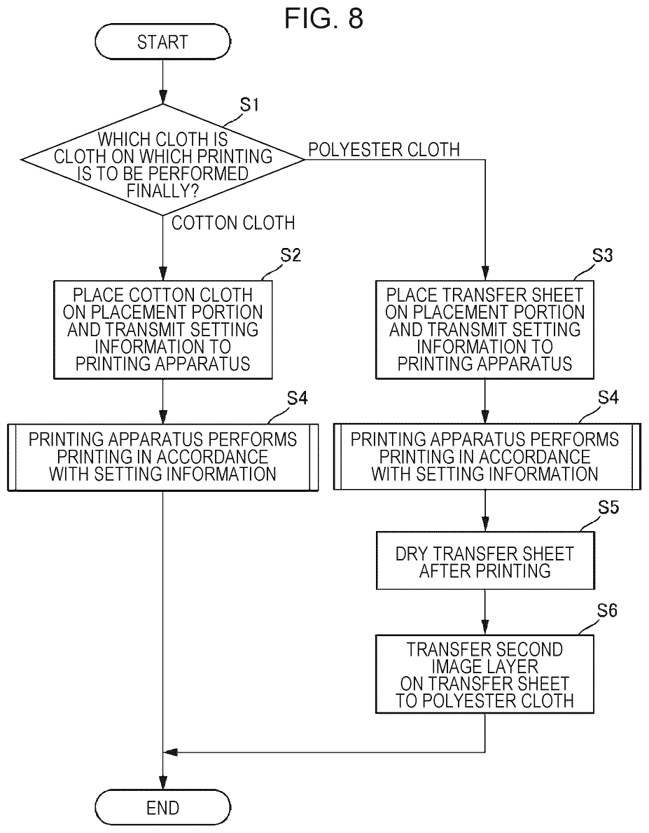

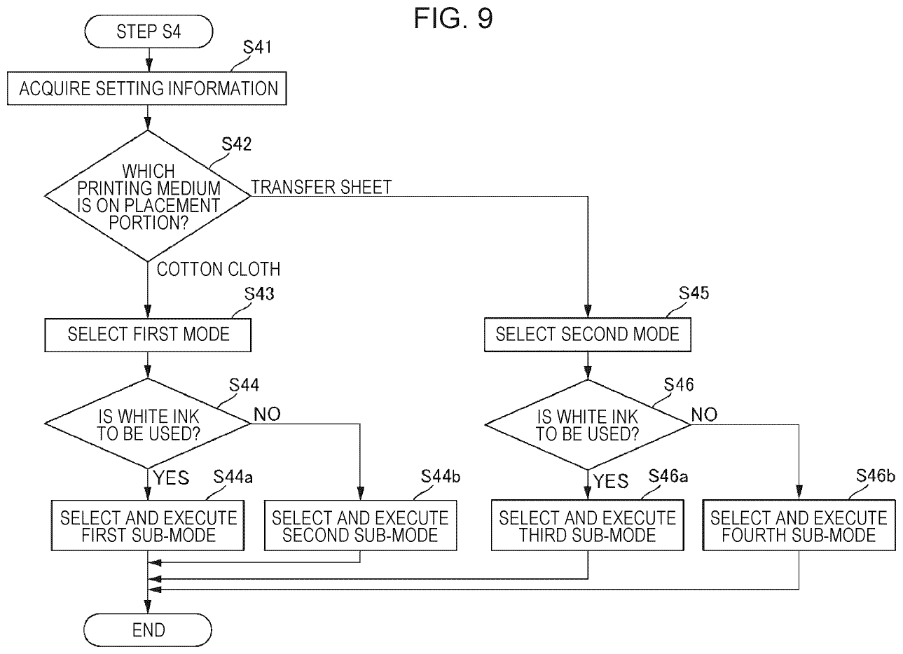

FIG. 8 is a flowchart showing the printing method according to the present embodiment. FIG. 9 is a flowchart (a subroutine) showing details of a step S4 in which the printing apparatus 1 performs printing in accordance with setting information in FIG. 8.

First, an operator performs a step S1 of determining whether a cloth on which printing is to be performed finally is the cotton cloth M1 or the polyester cloth M3. The operator can determine the material of the cloth based on, for example, a mixing ratio or the like described on the cloth or a tag attached to the cloth.

When the cloth on which printing is to be performed finally is the cotton cloth M1 (S1: cotton cloth), the operator performs a step S2 of mounting the cotton cloth M1 on the mounting portion 10 and transmitting setting information to the printing apparatus 1. Similarly, when the cloth on which printing is to be performed finally is the polyester cloth M3 (S1: polyester cloth), the operator performs a step S3 of mounting the transfer sheet M2 on the mounting portion 10 and transmitting setting information to the printing apparatus 1.

After either the step S2 or the step S3, the printing apparatus 1 performs a step S4 of performing printing in accordance with the setting information. Specifically, as shown in FIG. 9, first, the acquisition section 42a of the controller 40 performs a step S41 of acquiring the setting information via the communication section 43.

Next, the selection section 42b performs a step S42 of determining whether a printing medium mounted on the mounting portion 10 is the cotton cloth M1 or the transfer sheet M2 based on the setting information.

When it is determined in the step S42 that the printing medium mounted on the mounting portion 10 is the cotton cloth M1 (S42: cotton cloth), the selection section 42b performs a step S43 of selecting the first mode. Next, the selection section 42b performs a step S44 of selecting whether or not the white ink is to be used, based on the setting information.

When the selection section 42b selects to use the white ink in the step S44 (S44: YES), the selection section 42b performs a step S44a of selecting and executing the first sub-mode. In this case, the first background layer Pw1 and the first image layer Pc1 are formed at the cotton cloth M1 in this order. When the selection section 42b selects to use no white ink in the step S44 (S44: NO), the selection section 42b performs a step S44b of selecting and executing the second sub-mode. In this case, the first image layer Pc1 is formed at the cotton cloth M1. In this manner, an image corresponding to image data of the setting information is printed on the cotton cloth M1. Printing on the cotton cloth M1 is ended in this manner.

In addition, when it is determined in the step S42 that the printing medium mounted on the mounting portion 10 is the transfer sheet M2 (S42: transfer sheet), the selection section 42b performs a step S45 of selecting the second mode. Next, the selection section 42b performs a step S46 of selecting whether or not the white ink is to be used, based on the setting information.

When the selection section 42b selects to use the white ink in the step S46 (S46: YES), the selection section 42b performs a step S46a of selecting and executing the third sub-mode. In this case, the second image layer Pc2, the second background layer Pw2, and the adhesive layer Pg2 are formed at the transfer sheet M2 in this order. When the selection section 42b selects to use no white ink in the step S46 (S46: NO), the selection section 42b performs a step S46b of selecting and executing the fourth sub-mode. In this case, the second image layer Pc2 and the adhesive layer Pg2 are formed at the transfer sheet M2 in this order. In this manner, an inverted image of the image data of the setting information is printed on the transfer sheet M2.

Next, as shown in FIG. 8, the operator performs a step S5 in which the transfer sheet M2 subjected to the printing is removed from the printing apparatus 1 and is installed on a dryer and the dryer dries the transfer sheet M2 subjected to the printing.

Next, the operator performs a step S6 in which the dried transfer sheet M2 is removed from the dryer and is installed on the transfer machine and the transfer machine transfers, to the polyester cloth M3, the second image layer Pc2 of the dried transfer sheet M2. Specifically, the adhesive layer Pg2 of the transfer sheet M2 is affixed to the polyester cloth M3 and is heat-pressed. Accordingly, the adhesive layer Pg2 is thermally welded to the polyester cloth M3. Next, the transfer sheet M2 is separated from the second image layer Pc2. In this manner, the image data of the setting information is printed on the polyester cloth M3. Printing on the polyester cloth M3 is ended in this manner.

Although the printing apparatus 1 and the printing method according to the present embodiment have been described above, the printing apparatus 1 and the printing method are not limited thereto.

For example, a configuration in which whether or not the white ink is to be used can be selected in any one of the first mode and the second mode and the white ink is always used in the other one of the first mode and the second mode unlike the present embodiment can also be adopted. In addition, a configuration in which whether or not the white ink is to be used can be selected in any one of the first mode and the second mode and the white ink is always not used in the other one of the first mode and the second mode can also be adopted.

In addition, for example, the printing apparatus 1 may be provided with a detector that acquires detection data with which it is possible to determine the material or the like of a printing medium mounted on the mounting portion 10, the acquisition section 42a may acquire the detection data from the detector, and the selection section 42b may specify the material or the like of the printing medium based on the acquired detection data and select a mode in accordance with the result of the specification. The detector is not particularly limited as long as the detector can acquire the detection data with which it is possible to determine whether the printing medium mounted on the mounting portion 10 is the cotton cloth M1 or the transfer sheet M2 and examples thereof include a camera that images a printing medium, an optical detector in which laser light is used as a light source, an electrostatic capacitance sensor, and an electrical resistance measuring instrument. In this case, the material of the printing medium can be determined based on the surface properties, the degree of gloss, the thickness, and the like of the printing medium.

In addition, in this case, when it is determined based on the detection data that the printing medium is the polyester cloth M3, notification indicating that the polyester cloth M3 mounted on the mounting portion 10 is to be replaced with the transfer sheet M2 may be performed. Regarding the notification, the printing apparatus 1 may be provided with a notification section that notifies a user about information by means of a sound or a display and the notification section of the printing apparatus 1 may perform the notification and when the operation terminal 2 of the user is provided with the notification section, the notification section of the operation terminal 2 may perform the notification.

In addition, a dryer that dries the transfer sheet M2, a transfer machine that transfers an image on the transfer sheet M2 to the polyester cloth M3, or the like may be incorporated into the printing apparatus 1.

As described above, the printing apparatus 1 according to the present embodiment includes the mounting portion 10 on which the cotton cloth M1 or the transfer sheet M2 is selectively mounted, the printing section 30 that can discharge the ink for image formation and the adhesive liquid, and the controller 40 that controls the operation of the printing section 30. The controller 40 includes the selection section 42b that selects one of the first mode or the second mode. In the first mode, the operation of the printing section 30 is controlled such that the ink for image formation is discharged toward the cotton cloth M1 mounted on the mounting portion 10 so that the first image layer Pc1 is formed. In the second mode, the operation of the printing section 30 is controlled such that the ink for image formation is discharged toward the transfer sheet M2 mounted on the mounting portion 10 so that the second image layer Pc2 is formed and the adhesive liquid is discharged toward the second image layer Pc2 after formation of the second image layer Pc2 so that the adhesive layer Pg2 is formed.

As described above, in the case of the cotton cloth M1, the robustness and the texture of a printed image can be made favorable when printing is performed in the first mode. In addition, in the case of a cloth having relatively high hydrophobicity such as the polyester cloth M3, the robustness and the texture of a printed image can be made favorable when printing is performed on the transfer sheet M2 first in the second mode and then a printed image on the transfer sheet M2 is transferred to the cloth. Therefore, an image can be made less likely to be cracked or damaged when a cloth such as the cotton cloth M1 and the polyester cloth M3 is washed. That is, it is possible to ensure the robustness of a printed image and to ensure the favorable texture of a cloth in a printing region in accordance with the material of the cloth on which printing is performed.

In addition, the printing section 30 can further discharge the white ink. The selection section 42b can further select whether or not the white ink is to be used when the first mode is selected. When the white ink is to be used in the first mode, the printing section 30 forms the first image layer Pc1 after the white ink is discharged toward the cotton cloth M1. The selection section 42b can further select whether or not the white ink is to be used when the second mode is selected. When the white ink is to be used in the second mode, the printing section 30 discharges the white ink toward the second image layer Pc2 after the second image layer Pc2 is formed.

Since whether or not the white ink is to be used can be selected in both the first mode and the second mode, the degree of freedom of the design of an image that can be printed on a printing medium is increased. In addition, when the white ink is used, the color development properties of the first image layer Pc1 and the second image layer Pc2 can be improved.

In addition, the amount of application W1 of the white ink applied to the cotton cloth M1 in the first mode is larger than the amount of application W2 of the white ink applied to the transfer sheet M2 in the second mode. The time interval Δt1 between the end of discharge of the white ink and the start of discharge of the ink for image formation in the first mode is larger than the time interval Δt2 between the end of discharge of the white ink and the start of discharge of the adhesive liquid in the second mode.

In this manner, regarding the cotton cloth M1 having relatively high water absorbency, it is possible to sufficiently desolventize the white ink applied onto the cotton cloth M1 while securing the thickness of the first background layer Pw1 formed at the cotton cloth M1 by setting the amount of application W1 of the white ink to be relatively large and setting the time interval Δt1 to be relatively long. Meanwhile, regarding the transfer sheet M2 having relatively low water absorbency, it is possible to shorten a printing time while suppressing the amount of use of the white ink by setting the amount of application W2 of the white ink to be relatively small and setting the time interval Δt2 to be relatively short.

In addition, the printing section 30 includes the ink jet head 31 that discharges the ink for image formation and the adhesive liquid. The ink jet head 31 is relatively movable with respect to the mounting portion 10 in the main scanning direction a2 and the sub-scanning direction a3 intersecting the main scanning direction a2. In the second mode, the ink jet head 31 performs discharge during both the forward movement and the backward movement in the sub-scanning direction a3.

Therefore, a printing time can be shortened.

In addition, the adhesive liquid contains polyester.

Therefore, the adhesive layer Pg2 has high affinity to the polyester cloth M3. Accordingly, when the second image layer Pc2 is transferred from the transfer sheet M2 to the polyester cloth M3, the second image layer Pc2 can be caused to firmly adhere to the polyester cloth M3 via the adhesive layer Pg2. As a result, the robustness of a printed image on the polyester cloth M3 is improved.

In the printing method according to the present embodiment, whether a printing medium mounted on the mounting portion 10 is the cotton cloth M1 or the transfer sheet M2 is specified. When the printing medium mounted on the mounting portion 10 is the cotton cloth M1, the first mode, in which the ink for image formation is discharged toward the cotton cloth M1 from the printing section 30 so that the first image layer Pc1 is formed, is selected to be executed. When the printing medium mounted on the mounting portion 10 is the transfer sheet M2, the second mode, in which the ink for image formation is discharged toward the transfer sheet M2 from the printing section 30 so that the second image layer Pc2 is formed and then the adhesive liquid is discharged toward the second image layer Pc2 so that the adhesive layer Pg2 is formed, is selected to be executed.

Therefore, it is possible to ensure the robustness of a printed image and to ensure the favorable texture of a cloth in a printing region in accordance with the material of the cloth on which printing is performed.

In addition, the transfer sheet M2 is dried after the second mode is executed with respect to the transfer sheet M2 mounted on the mounting portion 10, and the adhesive layer Pg2 of the transfer sheet M2 is affixed to the polyester cloth M3 to transfer the second image layer Pc2 to the polyester cloth M3.

Therefore, the robustness and texture of a printed image on the polyester cloth M3 can be made favorable.

### Second Embodiment

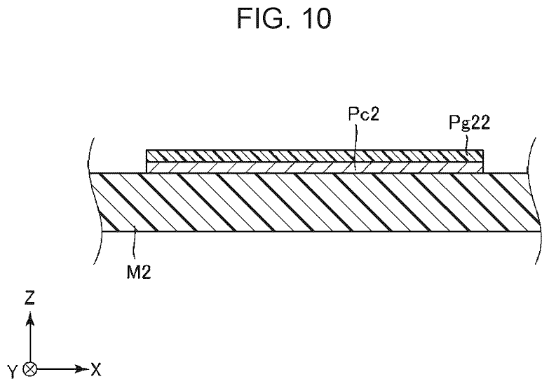

FIG. 10 is a cross-sectional view showing a portion of the transfer sheet M2 on which printing is performed by means of the printing apparatus 1 according to a second embodiment.

The printing apparatus 1 and the printing method according to the present embodiment are different from the printing apparatus 1 and the printing method according to the first embodiment in that the printing section 30 discharges the white ink and the adhesive liquid at the same time when the white ink is to be used in the second mode, that is, in the third sub-mode. Note that in the present embodiment, the difference between the second embodiment and the first embodiment will be mainly described, and the same configurations and methods as those of the first embodiment will be given the same reference numerals and description thereof will be omitted as appropriate.

In the third sub-mode, the driving controller 42c controls the operation of the printing section 30 such that the white ink and the adhesive liquid are discharged at the same time. In addition, the driving controller 42c controls the operation of the printing section 30 such that the white ink and the adhesive liquid are discharged with an adhesion region of the white ink overlapping with an adhesion region of the adhesive liquid as seen in plan view. Here, the expression “same time” means substantially the same time and time periods in which two types of discharging target liquid are discharged only need to partially overlap with each other at least. In addition, here, the expression “adhesion regions overlap each other” means not only a case where the two adhesion regions completely overlap each other but also a case where one of the two adhesion regions sticks out from the other adhesion region although the two adhesion regions overlap each other. Therefore, as shown in FIG. 10, a white adhesive layer Pg22 composed of the white ink and the adhesive liquid is formed at the second image layer Pc2. That is, in the present embodiment, the adhesive layer Pg22 has both a function as an adhesive layer and a function as a second background layer. Accordingly, the total layer thickness can be reduced in comparison with a case where the adhesive layer Pg2 and the second background layer Pw2 shown in FIG. 3 are formed separately. As a result, the reduction in total layer thickness contributes to improvement in robustness of a printed image.

Even in the case of the present embodiment, as with the first embodiment, it is possible to ensure the robustness of a printed image and to ensure the favorable texture of a cloth in a printing region in accordance with the material of the cloth on which printing is performed.

In addition, when the white ink is to be used in the second mode, the printing section 30 discharges the white ink and the adhesive liquid at the same time and an adhesion region of the white ink overlaps with an adhesion region of the adhesive liquid as seen in plan view.

When the white ink is used in the second mode, although the number of types of discharging target liquid is increased, printing can be efficiently performed and a printing time can be shortened since the white ink and the adhesive liquid are discharged at the same time. In addition, since the adhesive layer Pg22 has both a function as an adhesive layer and a function as a second background layer, the total layer thickness can be reduced, which contributes to improvement in robustness of a printed image.

Although the printing apparatus and the printing method according to the present disclosure have been described with reference to the embodiments shown in the drawings, the present disclosure is not limited thereto. Each unit constituting the printing apparatus and each step constituting the printing method can be replaced with any configuration and any step that can exhibit the same function. In addition, any component and any step may be added to the printing apparatus and the printing method.

What is claimed is:

1. A printing apparatus comprising:
a mounting portion on which a cotton cloth or a transfer sheet is selectively mounted;
a printing section that is configured to discharge ink for image formation and adhesive liquid; and
a controller that controls operation of the printing section, wherein
the controller includes a selection section that selects one of
a first mode in which the operation of the printing section is controlled such that the ink for image formation is discharged toward the cotton cloth mounted on the mounting portion so that a first image layer is formed, and
a second mode in which the operation of the printing section is controlled such that the ink for image formation is discharged toward the transfer sheet mounted on the mounting portion so that a second image layer is formed and the adhesive liquid is discharged toward the second image layer after formation of the second image layer so that an adhesive layer is formed.

2. The printing apparatus according to claim 1, wherein
the printing section is configured to further discharge white ink,
the selection section is configured to further select whether or not the white ink is to be used when the first mode is selected,
when the white ink is to be used in the first mode, the printing section forms the first image layer after the white ink is discharged toward the cotton cloth,
the selection section is configured to further select whether or not the white ink is to be used when the second mode is selected, and
when the white ink is to be used in the second mode, the printing section discharges the white ink toward the second image layer after the second image layer is formed.

3. The printing apparatus according to claim 2, wherein
when the white ink is to be used in the second mode, the printing section discharges the white ink and the adhesive liquid at the same time and an adhesion region of the white ink overlaps with an adhesion region of the adhesive liquid as seen in plan view.

4. The printing apparatus according to claim 2, wherein
an amount of application of the white ink applied to the cotton cloth in the first mode is larger than an amount of application of the white ink applied to the transfer sheet in the second mode, and
a time interval between end of discharge of the white ink and start of discharge of the ink for image formation in the first mode is longer than a time interval between end of discharge of the white ink and start of discharge of the adhesive liquid in the second mode.

5. The printing apparatus according to claim 1, wherein
the printing section includes an ink jet head that discharges the ink for image formation and the adhesive liquid,
the ink jet head is relatively movable with respect to the mounting portion in a main scanning direction and a sub-scanning direction intersecting the main scanning direction, and
in the second mode, the ink jet head performs discharge during both a forward movement and a backward movement in the sub-scanning direction.

6. The printing apparatus according to claim 1, wherein
the adhesive liquid contains polyester.

7. A printing method comprising:
specifying whether a printing medium mounted on a mounting portion is a cotton cloth or a transfer sheet;
selecting a first mode, in which ink for image formation is discharged toward the cotton cloth from a printing section so that a first image layer is formed, to be executed when the printing medium mounted on the mounting portion is the cotton cloth; and
selecting a second mode, in which the ink for image formation is discharged toward the transfer sheet from the printing section so that a second image layer is formed and then adhesive liquid is discharged toward the second image layer so that an adhesive layer is formed, to be executed when the printing medium mounted on the mounting portion is the transfer sheet.

8. The printing method according to claim 7, further comprising:
drying the transfer sheet after the second mode is executed with respect to the transfer sheet mounted on the mounting portion; and
affixing the adhesive layer of the transfer sheet to a polyester cloth to transfer the second image layer to the polyester cloth.
